(19) United States
(12) Patent Application Publication
(10) Pub. No.: US 2023/0399756 A1
(43) Pub. Date: Dec. 14, 2023

(54) APPARATUS FOR THE ELECTROLYTIC PRODUCTION OF HYDROGEN

(71) Applicant: WS SLOT SA, Lausanne (CH)

(72) Inventor: Ricardo CUARTERO GARCIA-MORATO, Le Mont-sur-Lausanne (CH)

(21) Appl. No.: 18/253,491

(22) PCT Filed: Nov. 15, 2021
(86) PCT No.: PCT/IB2021/060544

§ 371 Date: May 18, 2023

(30) Foreign Application Priority Data
Nov. 19, 2020 (EP) 20208730.0

(51) Int. Cl. C25B 1/04; C25B 15/08; C25B 15/023

(52) U.S. Cl. CPC C25B 1/04; C25B 15/083; C25B 15/023

(57) ABSTRACT

The invention concerns an apparatus for the electrolytic production of hydrogen comprising: —a first chamber (26) filled with water; —a lower part (23); —an upper part (28); —a gas production unit (1) located within the lower part (23) and including an electrolytic cell and a hydrogen nozzle (4); —an electric generator (12) located within the upper part (28); —a first driving mechanism (5-9) located within the first chamber (26); —a hydrogen outlet (18) located in the top part of the first chamber (26); the first chamber (26) being located between the lower and upper parts (23,28) and communicating with the gas unit (1) via the hydrogen nozzle (4), in such a way that hydrogen bubbles may be generated within the water of the first chamber (26) and be directed in an upwards direction due to the buoyancy force acting on the bubbles; the first driving mechanism (5-9) being adapted to be actuated by ascending bubbles; the generator (12) being adapted to be actuated by the first driving mechanism (5-9); and the electrolytic cell being connected to the electric generator (12). The invention also concerns a method for the production of hydrogen comprising the following steps: —generating hydrogen in water via electrolysis, —actuating an upwardly oriented driving mechanism with hydrogen bubbles generated during said electrolysis, —converting the mechanical energy of the driving mechanism into an electrical energy, —using said electrical energy for said electrolysis.

### FIELD OF INVENTION

The present invention generally relates to the production of hydrogen and more precisely to the production of hydrogen with an electrolytic cell.

### BACKGROUND

Electrolytic cells are used for inducing chemical reactions from electrical energy.

An electrolytic cell is often used to decompose chemical compounds in a process named electrolysis. In the case of electrolysis of water, the decomposition produces hydrogen gas and oxygen gas. To initiate such a reaction, it is necessary to apply sufficient electrical energy to break the bonds within the molecule, which results in the production of ions (anion and cation). The supply of electric power is made by electrodes in contact with the electrolyte. The negatively charged electrode is called the cathode and the positively charged electrode is called the anode. The ions in the form of gas are directed to and gather in the proximity of their respective electrodes, according to their positive or negative charge. In the case of the water molecule, which is composed of two atoms of hydrogen and one of oxygen through covalent bonds, hydrogen in the form of gas will appear at the cathode and oxygen at the anode. Hence, to produce hydrogen and/or oxygen gases, the electrolytic cell needs to be filled with water and to be provided by sufficient electric power.

For the existing electrolytic cells, the electric power is provided by common energy sources such as nuclear, thermal, hydraulic, wind or solar.

Using those energy sources may however show some disadvantages. They may not always be available, in particular the renewable ones. Some produce relatively high quantities of CO2. Their size, especially for the production of hydrogen, may also be relatively important.

Furthermore, the electric power presently used for electrolysis is often much higher than what is actually required. As a consequence, the yield in the production of hydrogen, for instance to be used as an energy vector transportation, is very low.

There is therefore a need to improve the existing production of gases with electrolytic cells, in particular the production of hydrogen.

### GENERAL DESCRIPTION OF THE INVENTION

A first objective of the present invention is to provide an apparatus and a method for the industrial production of green hydrogen with a high degree of energy autonomy to overcome its current limitations.

A second objective of the present invention is to optimize the use of electricity for the electrolytic production of hydrogen.

The inventive concept is based on the use of the buoyancy force imparted on hydrogen and oxygen gas bubbles produced from water electrolysis to generate electricity for the said electrolysis.

The invention more precisely consists of an apparatus for the electrolytic production of hydrogen comprising:
a first chamber filled with water;
a lower part;
an upper part;
a gas production unit located within the lower part and including an electrolytic cell and a hydrogen nozzle;
an electric generator located within the upper part;
a first driving mechanism located within the first chamber;
a hydrogen outlet located in the top part of the first chamber;
the first chamber being located between the lower and upper parts and communicating with the gas unit via the hydrogen nozzle, in such a way that hydrogen bubbles may be generated within the water of the first chamber and be directed in an upwards direction due to the buoyancy force acting on the bubbles;
the first driving mechanism being adapted to be actuated by ascending bubbles;
the generator being adapted to be actuated by the first driving mechanism; and
the electrolytic cell being connected to the electric generator.

The invention also concerns a method for the production of hydrogen comprising the following steps:

Method for the production of hydrogen comprising the following steps:
generating hydrogen in water via electrolysis,
actuating an upwardly oriented driving mechanism with hydrogen bubbles generated during said electrolysis,
converting the mechanical energy of the driving mechanism into an electrical energy,
using said electrical energy for said electrolysis.

More specific embodiments of the inventions are disclosed in the dependent claims.

As mentioned previously, the present invention is based on the observation that a gas in a liquid medium moves with the same force as a liquid in a gaseous environment. The difference in density between the two substances makes them move one into the other until a density balance is reached, as if they were two fluids, regardless their state (gaseous or liquid). The same would happen with two liquids or two gases with very different densities. The difference in density is proportional to the force that generates the fluid movement.

Hydrogen gas in air is very volatile. It shows a very fast rising speed due to its density being much lower than the air density. If air is replaced with water, the density difference is much greater. Consequently, the force imparted on hydrogen bubbles in water is relatively important, to such an extent that the force resulting from the rising movement of hydrogen bubbles may activate a driving mechanism, such as a wheel-type mechanism, and thereby could provide a mechanical energy to an electric generator.

In a preferred embodiment of the invention, the gas production unit and the electric generator driving mechanism are in the same volume, being immersed in the same liquid that feeds the electrolysis. In the case of hydrogen production, the liquid is water, with or without catalysts or dissolved elements depending on the nature of the electrodes or technology selected.

The gas production unit is preferably located at the bottom of the chamber. This unit, which is essentially an electrolysis system, is powered through an electrical conductor that carries the electrical current to the electrodes (cathode and anode) of the electrolytic cell. The ions produced separate inside the electrolysis system according to their positive or negative charge. In the case of water, hydrogen is separated from oxygen. When the ions are separated in the form of gas, they leave the electrolysis system through their corresponding nozzles, preferably separated so that there is no possibility that the gases can mix up.

Once the gases have left the gas production unit in the form of bubbles, they rise rapidly and are directed towards the lower part of the driving mechanism. This latter one may advantageously comprise paddles in the form of bowls or similar hollow containers which may be affixed to a chain or belt. The bowls located just above the nozzles of the hydrogen and oxygen gases from the gas production unit begin to rise due to the upward thrust produced by said gases, as these are trapped inside, moving upwards and allowing for subsequent bowls to trap more of the buoyant gases, thus driving the mechanism.

The number of bowls affixed to each chain or belt may vary depending on the height/depth of the chamber. When the first bowl filled with gas reaches the top of the driving mechanism, it rotates around the upper axis and turns upside down, thereby releasing the gas and leaving the cavity to be filled with the liquid as it submerges back into it. This point marks the liquid level required to harness the maximum buoyancy force within the apparatus. This action goes on as long as the buoyant gases continue to flow pushing the bowls upwards through the mechanism.

The gases may be recovered for storage, or rerouted for further use, from the upper part of the driving mechanism.

Each chain preferably carries bowls affixed along its entire length, with the spacing between two adjacent bowls optimized to capture as much as possible of the buoyant gas without blocking or interfering with the next. Their length should be determined to sustain the mechanical power required to generate as much as possible of the electricity consumed by the electrolysis system in generating hydrogen and oxygen. This energy may certainly be used to drive other appliances or auxiliary systems, e.g. to compress the gases for storage or to drive an atmospheric water generator that extracts from humid ambient air to be used in electrolysis.

Since two gases are produced in the separation of the fluid by electrolysis, two chains or belts may be installed, both connected to the same electrical generator but respectively driven by one of the gases within separate vertical pipelines. In most cases the volume and density of the two gases produced is not the same, so the size or number of bowls may vary, accordingly. In the case of water, the volume of the oxygen is half the volume of hydrogen produced.

Depending on the efficiency of the apparatus, the buoyancy force exerted by the gases along the mechanism may not suffice to produce the exact same amount of electricity consumed by the electrolysis system. In such case, it may be accumulated, e.g. by means of flywheels, batteries or thermal storage, for subsequent use in driving the electrolysis system.

In another embodiment, the electrolysis system is not immersed in the water with the lower part that supports the vertical pipelines. Rather, it is located nearby with the gas nozzles being connected to the lower part of said chamber so that the bowls can be filled. This system allows the feeding fluid of the electrolysis system to be different from fluid contained in the vertical pipelines. This is advantageous as it allows to carry out seawater electrolysis, which represents a potential solution to grid-scale production of carbon-neutral hydrogen energy without reliance on (purified) freshwater, and without exposing the apparatus to seawater corrosion. When using electrolysis systems that consume purified freshwater, the vertical pipelines may be filled with same liquid, as distilled water and deionized water have a very low corrosion effect on metallic materials, such as the chains of the mechanism, even if the oxygen content is high.

In another embodiment the chains are replaced with a wheel of sufficient dimensions to accommodate as many bowls as necessary to generate the maximum possible electricity with the quantity of gases produced from electrolysis.

In another embodiment, the apparatus is a modular system consisting of a series of interconnected modules equipped with the same kind of mechanism that drives an electric generator located at the top of each one of them. This modular system is advantageous because it allows for an increased performance without increasing the height/depth of the apparatus, and it uses one gas production unit to produce the gases that run through the first module and are subsequently rerouted from the top chamber to the bottom chamber of the next module without being consumed in the process.

In another embodiment, the driving mechanism is slightly tilted to reduce power losses due to gas bubbles not being captured underneath the bowls, and the electric generator being located inside the upper axis, which has an enlarged diameter to increase angular momentum as it rotates driven by the chains or belts. This configuration provides increased efficiency also by reducing the friction of the mechanism.

First, the present invention is not restricted to any specific geography or weather condition. It is operable day or night, all year round, above or even below the surface. Second, the entire apparatus of the present invention may be submerged in large bodies of water such as lakes, or oceans. The abundant supply of electrolyte (water) in such large bodies also alleviates any possible problem of pumping or recirculating the electrolyte. Furthermore, electrolysis performed under high pressure, e.g. under a large body of water, is expected to contribute to the enabling and acceptance of technologies where hydrogen is the energy carrier between renewable energy resources and clean energy consumers. Third, the electrolytic cell can be turned into a modular system to increase its performance without increasing the height/depth of the apparatus. Irrespectively, the entire apparatus of the present invention requires very limited space and proportionately much less than PV- or wind power stations of similar capacity, Fourth, the present invention causes no noise or visual pollution, in difference to PV- and wind power stations.

### DETAILED DESCRIPTION OF THE INVENTION

To invention will be better understood in the present chapter, with some examples and the following figures:

FIG. 1 is a side view of an example of an apparatus according to the invention.

FIG. 2 is a front view of the apparatus of FIG. 1.

FIG. 3 shows the exit of gases from the production unit, and that are directed towards bowls.

FIG. 4 shows the upper part of the apparatus of the previous figures.

FIG. 5 shows how a notch allows a bowl to rotate without touching the nozzles from the gas production unit.

FIG. 6 is a front view of another example of the apparatus of the invention, as a modular system.

FIG. 7 is a side view of the driving mechanism slightly tilted and with the electric generator placed inside the upper axis.

### NUMERICAL REFERENCES USED IN THE FIGURES

1. Gas production unit
2. Water inlet
3. Oxygen nozzle
4. Hydrogen nozzle
5. Chain
6. Chain gear wheel
7. Bowl (7′ hydrogen bowl, 7″ oxygen bowl)
8. Notch
9. Rotating shaft
10. Liquid minimum level
11. Generator gear wheel
12. Electric generator
13. Revolution multiplier
14. Starting battery
15. Charge controller
16. External electric supply
17. Wall
18. Hydrogen outlet
19. Liquid maximum level
20. Liquid level detector
21. Lower sensor
22. Upper sensor
23. Lower part
24. Oxygen outlet
25. Electric wire
26. First chamber
27. Second chamber
28. Upper part
29. Gas line
30. Water inlet

Unless defined otherwise, all technical and scientific terms used herein have the same meaning as is commonly understood by one of ordinary skill in the art to which this invention belongs. Furthermore, the materials, methods, and examples are illustrative only and are not intended to be restrictive.

In the example illustrated in FIGS. 1 and 2 the apparatus according to the invention essentially consists of a column comprising a vertically oriented first chamber 26 filled with water, a vertically oriented second chamber 27 filled with water, a upper part 28 communicating with the second chamber 27 and a lower part 23 in which a gas production unit 1 is located. The gas production unit 1 comprises an electrolytic cell made of a cathode and an anode (not illustrated) that are immersed in an electrolyte which consists of water. The gas production unit 1 communicates with the first chamber 26 through a hydrogen nozzle 4 and with the second chamber 27 through an oxygen nozzle 3. Electrolysis may be induced within the unit 1 which results in the production of hydrogen and oxygen gas. Proton-Exchange Membrane (PEM) technology is preferably used, due to its better performance with irregular electrical charges and to be able to be used with distilled water.

Preferably, a Membrane Electrode Assembly (MEA) multiple electrode system of the PEM type is used. The electrodes are, encapsulated in a polymer that avoids being in contact with outside water, since it is intended to be immersed. For this it is necessary that the electrical connections are insulated and sealed to the outside.

The gas production unit 1 requires thermal energy, since an endothermic reaction occurs. If the unit 1 was surrounded by air its temperature would drop, thus reducing its performance. Having the unit 1 immersed, as it is the case in this example, increases its thermal conductivity and facilitate therefore the temperature stabilization without the need to implement a cooling system.

The unit 1 being immersed and with the water inlet 2 open does not require an inlet channeling, feeding on the water that surrounds it. At each end of the battery of MEAs (membrane electrodes) there is an exit for the gases (hydrogen and oxygen in the present example) that are conducted to respective nozzles 3, 4. Each nozzle 3, 4 communicates with a vertical chamber 26, 27 both chambers 26 being separated by a wall, to prevent the gas bubbles from mixing.

As shown on FIG. 3, the wall 17 does not completely separate the two chambers 26, 27 so that water can flow from one chamber 26, 27 to the other and fill them. In this example, water enters the chambers 26, 27 via the gas production unit 1, this latter one being connected via an inlet 2 to an external water source.

Inside each chamber 26, 27 is a driving mechanism comprising several bowls 7′, 7″ fixed to a chain 5 that forms a vertical loop. The chain 5 turns around two gear wheels 6 (one above and one below). Each bowl 7′, 7″ contains a notch 8 located externally on a bowl side that is opposite to the bowl internal side that contacts the chain 5. Providing a notch 8 facilitates and maximizes the entry of gas bubbles into the bowl when the chain 5 moves.

FIG. 2 shows the two rows of bowls 7′, 7″. Small bowls 7″(left column) are for oxygen and large bowls 7′(right column) are for hydrogen. This figure also shows the axes of the gears 6,11 and how the two rows interact on the gear with the largest diameter 11, this latter one acting on the electric generator 12 and a speed multiplier 13. A hydrogen outlet 18 (see FIGS. 1 and 2) and oxygen outlets 24 (see FIG. 2) are also shown.

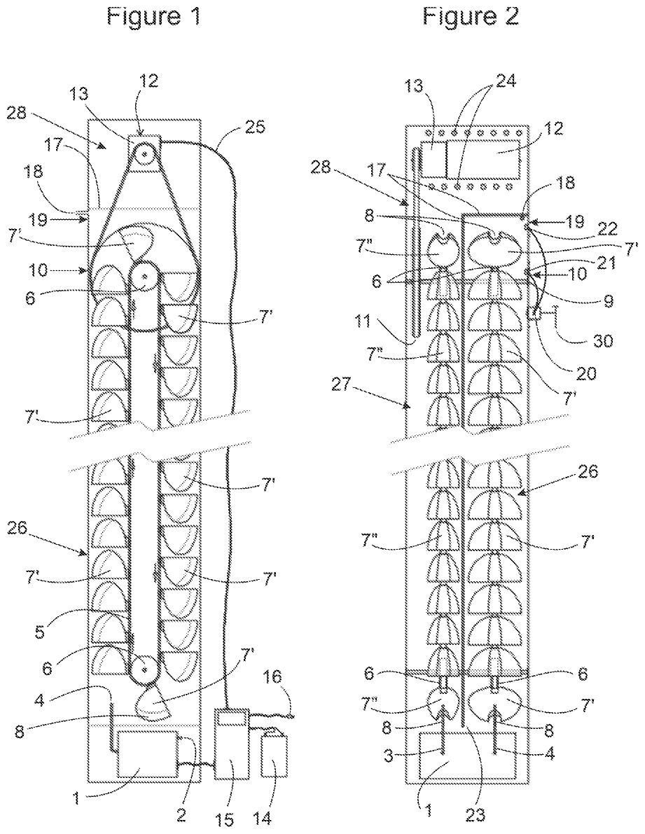

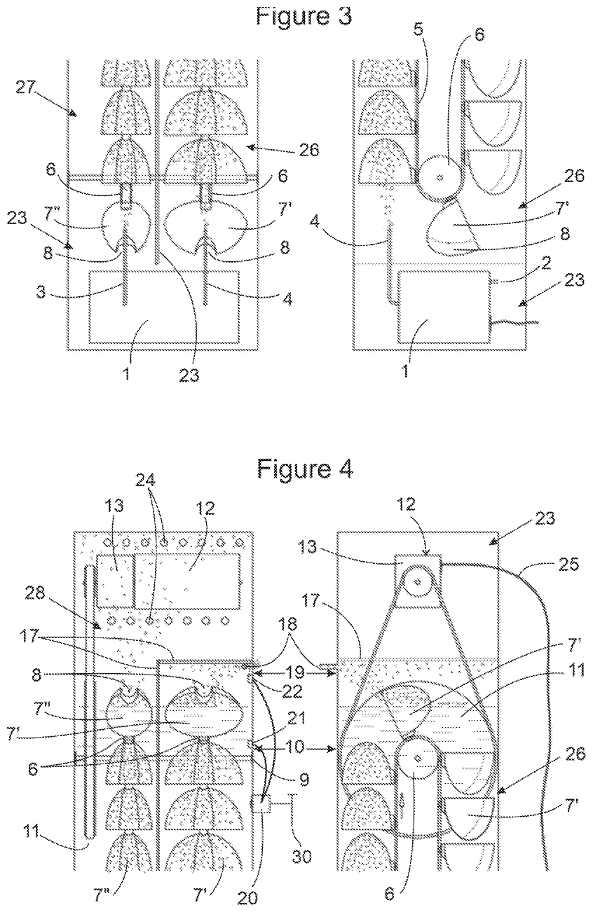

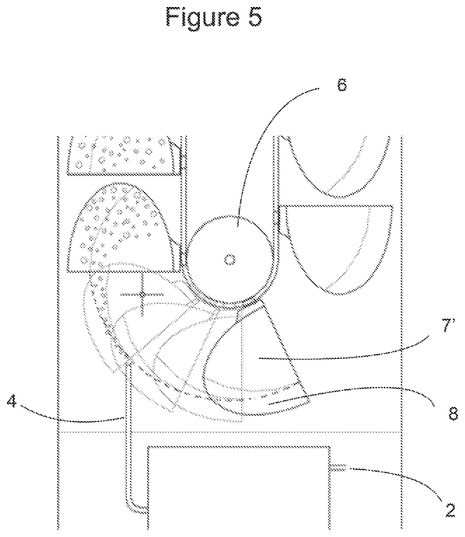

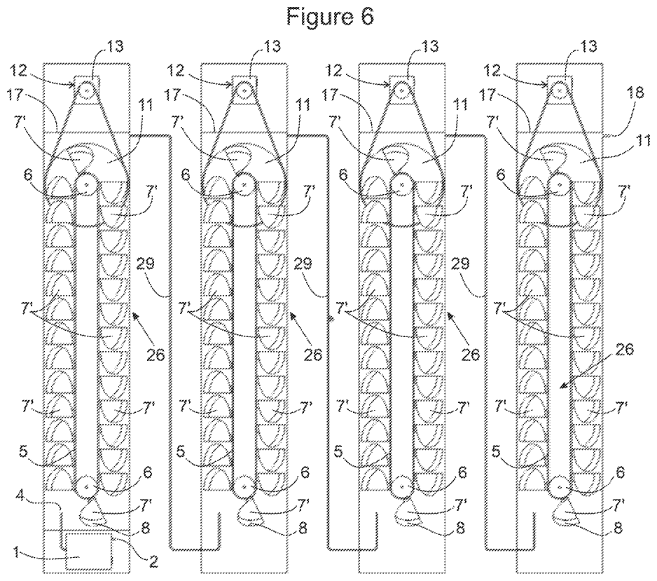

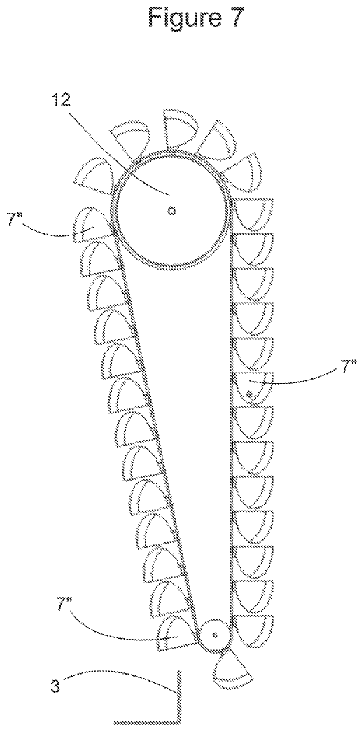

As mentioned previously, the hydrogen bowls 7′ are larger than the oxygen bowls 7″. This is due to the volume of hydrogen generated that is higher than the volume of oxygen. The oxygen bowls 7″ could have the same volume as the hydrogen ones 7′. It is however more advantageous to reduce their volume, but not their shape. By doing so, friction is reduced and energy losses are minimized.

In the upper part 28 are two gear wheels 6 fixed to a common rotating shaft 9 and that interact with the chains 5. The rotating shaft 9 is situated below the minimum water level 10. Another gear wheel 11, located in the second chamber 26, is also fixed on the rotating shaft 9. It interacts with the electric generator 12, via a belt and a revolution multiplier 13. This other gear wheel 11 has a different size to correct the rotational revolutions necessary for the electric generator 12, since the rotational speed of the gear wheels 6 connected to the bowls 7′, 7″ is slower than what is needed for the electric generator 12. This renders it necessary to include the said revolution multiplier 13. The multiplier factor is a function of the generator and its optimal revolutions.

A starting battery 14 is used to initiate the electrolysis within the gas production unit 1. The use of a direct current generator may facilitate the charging of the starting battery 14, but it could also well work with an alternating current generator. The starting battery 14 is connected by means of a charge controller 15. An external supply 16 of electric energy is also possible, if the energy in the system is higher to that required for electrolysis.

In the upper part 28 there is a space for the gear mechanism and for the electric generator 12. This space is devoid of liquid. It is also isolated from the first chamber, with horizontal and vertical walls 17. The hydrogen outlet 18 is as close as possible with respect to the said space.

The hydrogen outlet 18 is located just above the maximum level 19 that can be reached by the water. The water level must also be maintained above the rotating shaft 9. To guarantee the correct level of water, a liquid detector 20 is provided. Filling of the chambers via the water inlet 30 is activated when the water level is below the minimum level 10. The minimum level 10, respectively maximum level 19, are detected by a lower sensor 21, respectively upper sensor 22. To simplify the filling, the two chambers communicate in the lower part 23 but maintaining the nozzles 3,4 above to prevent the gases from mixing up in the chambers. It is important to keep the hydrogen pure in order to be used in reverse electrolysis cells.

The second chamber communicates with the external environment through outlets 24. Those outlets 24 are located within the space that contains the electric generator 12. By letting the gaseous oxygen go outside, as it is denser than the air, it descends through along the cell external wall, slightly heating the walls and transporting part of the heat from the upper part to the lower area where it is absorbed by the electrolysis process. This oxygen gas spreads over the surface near the device, improving the quality of breathable air.

The electric generator 12 is connected by a wire 25 outside the gas production unit 1, via the charge controller 15, which regulates the gas production depending on the battery charge. In this way, when the battery 14 is fully charged, all the electrical power can be allocated to the production of hydrogen.

FIG. 6 shows the apparatus as a modular system consisting of a series of interconnected modules equipped with the same kind of mechanism 5-8,11,13,17 that drives an electric generator 12 located at the top of each one of them. This modular system is advantageous because it uses one single gas production unit 1 placed inside the first module to produce the gases that run through its mechanism and are subsequently rerouted through a gas line 29 from the top chamber to the bottom chamber of the next module without being consumed in the process.

FIG. 7 shows the driving mechanism in a slightly tilted configuration to reduce power losses due to gas bubbles not being captured underneath each bowl 7′, 7″. The angular orientation of the belt increases the number of bubbles captured within the bowls 7′, 7″. Furthermore, the electric generator 12 being located inside the upper axis has an enlarged diameter to increase angular momentum as it rotates driven by the chains. This configuration provides increased efficiency also by reducing the friction of the mechanism.

The invention is of course not limited to those examples and figures but covers any alternative that is defined in the claims.

1. An apparatus for the electrolytic production of hydrogen comprising:
a first chamber filled with water;
a lower part;
an upper part;
a gas production unit located within the lower part and including an electrolytic cell and a hydrogen nozzle;
an electric generator located within the upper part;
a first driving mechanism located within the first chamber;
a hydrogen outlet located in the top part of the first chamber;
the first chamber being located between the lower and upper parts and communicating with the gas unit via the hydrogen nozzle, in such a way that hydrogen bubbles may be generated within the water of the first chamber and be directed in an upwards direction due to the buoyancy force acting on the bubbles;
the first driving mechanism being adapted to be actuated by ascending bubbles;
the generator being adapted to be actuated by the first driving mechanism;
and the electrolytic cell being connected to the electric generator.

2. Apparatus according to claim 1 furthermore comprising:
a second chamber filled with water, communicating with the upper part but being separated from the first chamber;
a second driving mechanism located within the second chamber;
at least one oxygen outlet being located within the upper chamber.
the gas production unit furthermore including an oxygen nozzle;
the second chamber communicating with the gas unit via the oxygen nozzle, in such a way that oxygen bubbles may be generated within the water of the second chamber and be directed in an upwards direction due to the buoyancy force acting on the bubbles;
the second driving mechanism being adapted to be actuated by ascending bubbles;
the generator being adapted to be actuated by the driving mechanism.

3. Apparatus cell according to claim 1 wherein the gas production unit is immersed in water.

4. Apparatus according to claim 3 wherein both chambers are in communication through a passage located in the lower part, below the nozzles, to avoid the mixing between hydrogen and oxygen bubbles.

5. Apparatus according to claim 2 wherein the generator is designed to be actuated by both driving mechanisms.

6. Apparatus according to claim 1 wherein the driving mechanism comprises a vertical chain or belt forming a closed loop that turns around an upper and a lower gear wheel, and several bowls fixed to the chain or belt.

7. Apparatus according to claim 6 wherein each bowl contains a notch that is located externally on a bowl side that is opposite to the bowl internal side that contacts the chain or belt.

8. Apparatus according to claim 6 comprising two driving mechanisms that use a single and same chain or belt.

9. Apparatus according to claim 5 wherein the chain or belt is inclined to the vertical, in such a way as to increase the number of bubbles captured by the bowls.

10. Apparatus according to claim 1 wherein the driving mechanism comprises a wheel and several bowls fixed to the wheel.

11. Apparatus according to claim 1 comprising a starting battery.

12. Apparatus according to claim 1 comprising a liquid detector made of at least one lower sensor and one upper sensor.

13. Apparatus according to claim 1 comprising a series of interconnected modules wherein the first module is identical to the apparatus as defined in any previous claims and wherein each subsequent module is also identical but devoid of a gas production unit.

14. Apparatus according to claim 1 wherein the first chamber is a well, a pool, a lake, a sea or any other similar liquid container.

15. Method for the production of hydrogen comprising the following steps:
generating hydrogen in water via electrolysis,
actuating an upwardly oriented driving mechanism with hydrogen bubbles generated during said electrolysis,
converting the mechanical energy of the driving mechanism into an electrical energy,
using said electrical energy for said electrolysis.
